(19) United States
(12) Patent Application Publication
(10) Pub. No.: US 2025/0077119 A1
(43) Pub. Date: Mar. 6, 2025

(54) RESIDUAL DATA WRITING METHOD AND APPARATUS, COMPUTER DEVICE, AND STORAGE MEDIUM

(71) Applicant: GLENFLY Technology (Beijing) Co., Ltd., Beijing (CN)

(72) Inventors: Wu HAO, Beijing (CN); Cong ZHU, Beijing (CN); Chuanchuan ZHU, Beijing (CN); Jiahui MA, Beijing (CN)

(21) Appl. No.: 18/608,407

(22) Filed: Mar. 18, 2024

(30) Foreign Application Priority Data
Sep. 6, 2023 (CN) 202311146051.0

(51) Int. Cl. G06F 3/06

(52) U.S. Cl. CPC G06F 3/0659; G06F 3/0613; G06F 3/0656; G06F 3/0673

(57) ABSTRACT

Disclosed are a residual data writing method and apparatus, a computer device, and a storage medium. The method includes: determining a residual data reading mode comprising a reading sequence of each piece of residual data, and the quantity of residual data read simultaneously at each time; determining the number of buffer groups and the number of buffers in each buffer group according to the residual data reading mode, wherein each buffer is provided with a unique buffer index, and each buffer comprises a plurality of buffer addresses; acquiring a buffer index and a buffer address corresponding to to-be-written residual data; and writing the to-be-written residual data into a corresponding buffer according to the buffer index and the buffer address.

### CROSS REFERENCES TO RELATED APPLICATION

The present application claims priority to Chinese patent application No. 202311146051.0, titled “Residual Data Writing Method and Apparatus, Computer Device, and Storage Medium”, and filed on Sep. 6, 2023, the content of which is hereby incorporated by reference in its entirety.

### TECHNICAL FIELD

The present disclosure relates to the field of video encoding and decoding technology, particularly to a residual data writing method and apparatus, a computer device, a storage medium, and a computer program product.

### BACKGROUND

With continuous updating of the encoding technology in the video encoding and decoding standards, the data volume for video encoding is constantly increasing. In order to improve a data compression rate, in the mainstream video encoding standards, inter-frame encoding is generally utilized to improve the video compression rate. In the inter-frame encoding, it is required to perform the difference between data of a current frame and data of a reference frame to obtain residual data, and perform the motion estimation with the residual data. With continuous updating of the encoding technology, the residual data volume increases constantly, and the access efficiency of the residual data greatly affects the encoding efficiency. Therefore, how to improve the access efficiency of the residual data is a problem that needs to be solved in the design of each encoder.

In conventional technology, motion estimation is divided into three phases: a coarse phase, a fine phase, and a fraction phase. The residual data is block data, and 16 pieces of residual data in every two pieces of 128-bit residual data in the coarse phase correspond to nine motion vectors. In the fine phase and the fraction phase, every two pieces of 128-bit data include data corresponding to 16 motion vectors. In an existing method, data corresponding to motion vectors is sequentially buffered in a row scanning sequence. For example, in the coarse phase, data corresponding to nine motion vectors is buffered according to a vector sequence, so that two pieces of 128-bit data need to be partitioned and spliced, and the data is stored in the SRAM nine times. In this manner, nine cycles are required to store two pieces of 128-bit residual data in the SRAM. For a 32×32 block, 512 pieces of residual data are required for each search, and 4608 cycles are required for buffering the data. The fine and fraction phases take longer to buffer the data, which leads to time redundancy for buffering the residual data, causing the encoder to be in an idle state for a long time, and seriously affecting the encoding efficiency of the encoder.

Currently, the writing time for the residual data is long, and accordingly, the access efficiency of the residual data is lower.

### SUMMARY

In view of this, as for the technical problem described above, it is necessary to provide a residual data writing method and apparatus, a computer device, a computer-readable storage medium, and a computer program product capable of improving the access efficiency of the residual data.

In the first aspect of the present disclosure, a residual data writing method is provided, including: determining a residual data reading mode comprising a reading sequence of each piece of residual data, and the quantity of residual data read simultaneously at each time; determining the number of buffer groups and the number of buffers in each buffer group according to the residual data reading mode, wherein each buffer is provided with a unique buffer index, and each buffer comprises a plurality of buffer addresses; acquiring a buffer index and a buffer address corresponding to to-be-written residual data; and writing the to-be-written residual data into a corresponding buffer according to the buffer index and the buffer address.

In an embodiment, determining the residual data reading mode may include: configuring a residual data reading circuit comprising two data interfaces which are configured to simultaneously read residual data corresponding to two adjacent motion vectors in each residual data reading process; and reading the residual data from the buffer at least once through the two data interfaces of the residual data reading circuit.

In an embodiment, determining the number of buffer groups and the number of buffers in each buffer group according to the residual data reading mode may include: determining residual data corresponding to two adjacent motion vectors read simultaneously in each residual data reading process according to the residual data reading mode, to configure two buffer groups; and configuring the same number of buffers in each buffer group.

In an embodiment, acquiring the buffer index and the buffer address corresponding to the to-be-written residual data may include: partitioning initial residual data acquired in a motion estimation target phase to obtain 16-bit to-be-written residual data; acquiring a vector coordinate corresponding to the to-be-written residual data according to a positional relationship between the to-be-written residual data and the initial residual data; acquiring a search center point corresponding to the initial residual data, obtaining a vector offset coordinate of the to-be-written residual data according to an offset between the vector coordinate and the search center point; and acquiring the buffer index and the buffer address corresponding to the to-be-written residual data according to the vector offset coordinate.

In an embodiment, acquiring the buffer index corresponding to the to-be-written residual data according to the vector offset coordinate may include: concatenating buffer lines of all buffers with the same buffer depth according to a buffer index of each buffer to obtain a concatenated buffer line; acquiring a concatenation width of the concatenated buffer line according to a width of a buffer line of each buffer; determining a first position mapping relationship between the to-be-written residual data and the concatenated buffer line according to the vector offset coordinate and the concatenation width; and determining a buffer group and a buffer corresponding to the to-be-written residual data according to the first position mapping relationship, to determine the buffer index corresponding to the to-be-written residual data.

In an embodiment, the to-be-written residual data may include first residual data and second residual data which correspond to two adjacent motion vectors, and the determining the buffer group and the buffer corresponding to the to-be-written residual data according to the first position mapping relationship to determine the buffer index corresponding to the to-be-written residual data may include: determining a plurality of target buffers having a corresponding relationship according to an arrangement sequence of buffers in each buffer group, wherein each of the target buffers belongs to a different buffer group, and the target buffers have the same arrangement sequence in respective corresponding buffer groups; acquiring a difference parameter according to a buffer index of each target buffer; determining a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data; when the first buffer index is the same as the second buffer index, correcting the second buffer index according to the difference parameter to obtain a third buffer index; and determining the first buffer index as a buffer index corresponding to the first residual data, and determining the third buffer index as a buffer index corresponding to the second residual data.

In an embodiment, acquiring the buffer address corresponding to the to-be-written residual data according to the vector offset coordinate may include: determining a second position mapping relationship between the to-be-written residual data and a buffer depth according to the vector offset coordinate and the search center point; and determining a buffer depth corresponding to the to-be-written residual data according to the second position mapping relationship, to determine the buffer address corresponding to the to-be-written residual data.

In an embodiment, writing the to-be-written residual data into the corresponding buffer according to the buffer index and the buffer address may include: generating a mask corresponding to the buffer index and the buffer address; and writing the to-be-written residual data into the corresponding buffer according to the buffer index, the buffer address, and the mask.

In the second aspect of the present disclosure, a residual data writing apparatus is further provided, including: a determination module, configured to determine a residual data reading mode comprising a reading sequence of each piece of residual data, and the quantity of parameter data read simultaneously at each time; a configuration module, configured to determine the number of buffer groups and the number of buffers in each buffer group according to the residual data reading mode, wherein each buffer is provided with a unique buffer index, and each buffer comprises a plurality of buffer addresses; an acquisition module, configured to acquire a buffer index and a buffer address corresponding to to-be-written residual data; and a writing module, configured to write the to-be-written residual data into a corresponding buffer according to the buffer index and the buffer address.

In the third aspect of the present disclosure, a computer device is further provided, including a processor and a memory storing a computer program, the processor, when executing the computer program, implements the steps of: determining a residual data reading mode comprising a reading sequence of each piece of residual data, and the quantity of residual data read simultaneously at each time; determining the number of buffer groups and the number of buffers in each buffer group according to the residual data reading mode, wherein each buffer is provided with a unique buffer index, and each buffer comprises a plurality of buffer addresses; acquiring a buffer index and a buffer address corresponding to to-be-written residual data; and writing the to-be-written residual data into a corresponding buffer according to the buffer index and the buffer address.

In the fourth aspect of the present disclosure, a computer-readable storage medium is provided, on which a computer program is stored, the computer program, when executed by a processor, causes the processor to implement the steps of: determining a residual data reading mode comprising a reading sequence of each piece of residual data, and the quantity of parameter data read simultaneously at each time; determining the number of buffer groups and the number of buffers in each buffer group according to the residual data reading mode, wherein each buffer is provided with a unique buffer index, and each buffer comprises a plurality of buffer addresses; acquiring a buffer index and a buffer address corresponding to to-be-written residual data; and writing the to-be-written residual data into a corresponding buffer according to the buffer index and the buffer address.

In the fifth aspect of the present disclosure, a computer program product is provided, including a computer program, the computer program, when executed by a processor, causes the processor to implement the steps of: determining a residual data reading mode comprising a reading sequence of each piece of residual data, and the quantity of parameter data read simultaneously at each time; determining the number of buffer groups and the number of buffers in each buffer group according to the residual data reading mode, wherein each buffer is provided with a unique buffer index, and each buffer comprises a plurality of buffer addresses; acquiring a buffer index and a buffer address corresponding to to-be-written residual data; and writing the to-be-written residual data into a corresponding buffer according to the buffer index and the buffer address.

In the above-mentioned residual data writing method and apparatus, computer device, storage medium, and the computer program product, a residual data reading mode is determined, which includes a reading sequence of each piece of residual data, and the quantity of parameter data read simultaneously at each time; the number of buffer groups and the number of buffers in each buffer group are determined according to the residual data reading mode, each buffer is provided with a unique buffer index, and each buffer comprises a plurality of buffer addresses; a buffer index and a buffer address corresponding to to-be-written residual data are acquired; and the to-be-written residual data is written into a corresponding buffer according to the buffer index and the buffer address. The residual data of different coordinates is written into the buffers at a time, in order to avoid writing residual data of only one coordinate at a time, thereby significantly reducing the clock period of data writing, greatly reducing the write time of the residual data, and improving the access efficiency of the residual data.

### BRIEF DESCRIPTION OF THE DRAWINGS

In order to describe the technical solution in the embodiments of the present disclosure or the related technologies more clearly, the accompanying drawings required for describing the embodiments or the related technologies will be briefly introduced below. Obviously, the accompanying drawings in the following description show merely some embodiments of the present disclosure, and a person of ordinary skill in the art may still obtain other drawings from these accompanying drawings without creative efforts.

FIG. 1 is a flow chart showing a residual data writing method according to an embodiment.

FIG. 2 is a flow chart of address mapping and data writing according to an embodiment.

FIG. 3 is a schematic diagram of obtaining residual data in a coarse search phase according to an embodiment.

FIG. 4 is a schematic diagram illustrating residual data in a coarse search phase according to an embodiment.

FIG. 5 is a schematic diagram illustrating a reading sequence of residual data according to an embodiment.

FIG. 6 is a flow chart of obtaining residual data in a fine search phase according to an embodiment.

FIG. 7 is a schematic diagram illustrating a storage layout in a fine search phase according to an embodiment.

FIG. 8 is a schematic diagram illustrating lateral mapping in a fine search phase according to an embodiment.

FIG. 9 is a structural block diagram illustrating a residual data writing apparatus according to an embodiment.

FIG. 10 is an internal structure diagram of a computer device according to an embodiment.

### DETAILED DESCRIPTION

In order to make the purpose, the technical solution and advantages of the present disclosure clearer, the present disclosure will be described in further detail with reference to the accompanying drawings and embodiments. It should be appreciated that the specific embodiments described herein are merely intended to explain the present disclosure, rather than limiting the present disclosure.

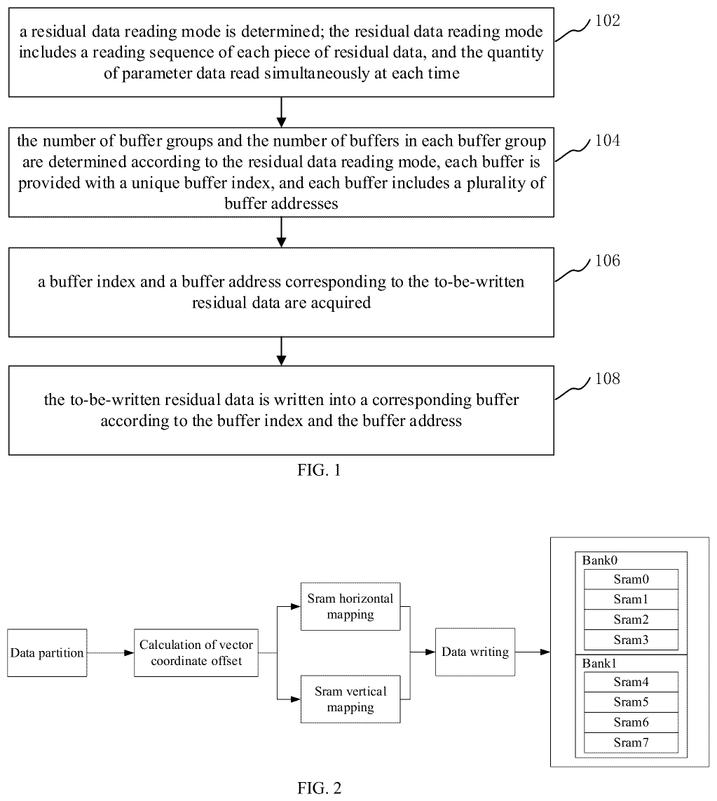

In an embodiment, as shown in FIG. 1, a residual data writing method is provided. In the exemplary embodiment, the method is applied to a computer device. It can be appreciated that the computer device may be specifically a terminal or a server. The terminal may be but is not limited to various personal computers, laptops, smartphones, tablets, Internet of Things devices, and portable wearable devices. The Internet of Things device may be an intelligent sound box, an intelligent television, an intelligent air conditioner, an intelligent medical device, or the like. The portable wearable device may be a smart watch, a smart bracelet, a headset device, and so on. The server may be an independent server or a server cluster composed of a plurality of servers. In the embodiment, the method may include the following steps 102 to 108.
Step 102: a residual data reading mode is determined. The residual data reading mode includes a reading sequence of each piece of residual data, and the quantity of residual data read simultaneously at each time.

Optionally, a residual data read circuit is configured according to the determined residual data reading mode. For example, in the residual data reading manner, residual data corresponding to two adjacent motion vectors is read at a time. The residual data read circuit may be provided with two data interfaces, and each data interface is connected to a group of buffers. During each residual data read, the two data interfaces respectively read two pieces of residual data from the two groups of buffers at the same time.
Step 104: the number of buffer groups and the number of buffers in each buffer group are determined according to the residual data reading mode. Each buffer is provided with a unique buffer index, and each buffer includes a plurality of buffer addresses.

The buffer group is represented with Bank, and the buffer is represented with Sram.

Optionally, when it is determined, according to the determined residual data reading mode, that residual data corresponding to two adjacent motion vectors needs to be read simultaneously in each residual data read process, two buffer groups are provided, and each buffer group includes the same number of buffers. For example, as shown in FIG. 2, two buffer groups Bank0 and Bank1 are provided, four buffers Sram0 to Sram3 are provided in the Bank0, and four buffers Sram4 to Sram7 are provided in the Bank1, so that there exists a total of eight buffers Sram. In such a manner, the two data interfaces of the residual data read circuit may be respectively connected to the Bank0 and the Bank1. When data is read each time, one piece of residual data may be read from each buffer group.

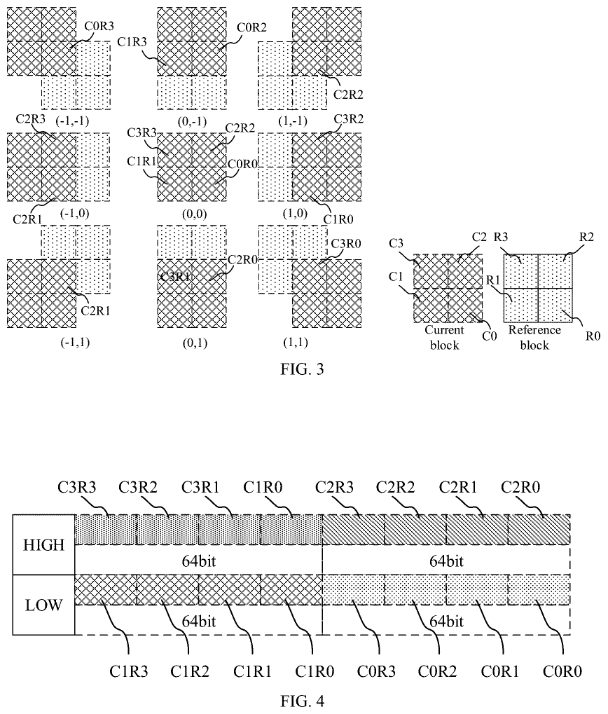

Specifically, the residual data in the Coarse search phase is a two-dimensional block data. As shown in FIG. 3, there are nine overlap modes between a current block and a reference block. A dark block is the current block, and a light block is the reference block. Sizes of all the blocks are each 16×16, and each block may be divided into four 8×8 sub-blocks. The residual data is the difference between each 8×8 sub-block of the current block and each 8×8 sub-block of the reference block. Nine motion vectors in FIG. 3 correspond to 16 pieces of residual data, and each piece of residual data is 16 bits, which are combined as shown in FIG. 4. A reading sequence of the residual data is shown in FIG. 5. A read circuit is provided with two data interfaces, and residual data corresponding to two adjacent motion vectors is read simultaneously.

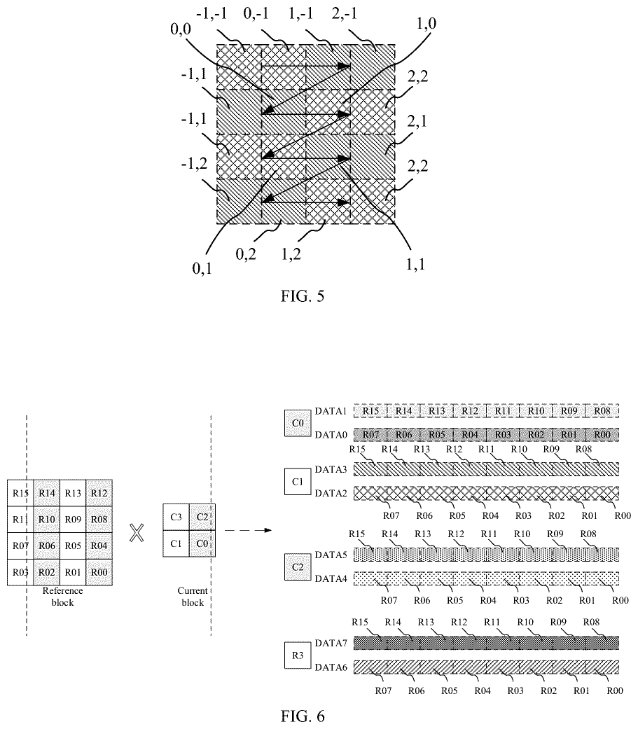

The residual data format in the fine search phase is shown in FIG. 6. The two pieces of 128-bit data include residual data of one 8×8 sub-block in the current block and residual data of all 8×8 sub-blocks within the 4×4 reference block. The reading sequence in the fine search phase is the same as that in the coarse search phase, and two pieces of residual data corresponding to two adjacent motion vectors are read in each cycle.
Step 106: a buffer index and a buffer address corresponding to the to-be-written residual data are acquired.

The buffer index is represented by “Index”, and the buffer address is represented by “Addr”.

Optionally, initial residual data acquired in the motion estimation target phase is partitioned to obtain 16-bit to-be-written residual data. A vector coordinate corresponding to the to-be-written residual data is acquired according to a positional relationship between the to-be-written residual data and the initial residual data. A search center point corresponding to the initial residual data is acquired, and a vector offset coordinate of the to-be-written residual data is obtained according to an offset between the vector coordinate and the search center point. The buffer index and the buffer address corresponding to the to-be-written residual data are acquired according to the vector offset coordinate.

Specifically, as shown in FIG. 2, data partition is first performed. The 256-bit residual data is partitioned into 16 pieces of 16-bit data. Then the calculation of the vector coordinate offset is performed. Specifically, the offset between the vector coordinate corresponding to each of the 16 pieces of data and the search center point is calculated, and the vector offset coordinates in a search range are determined. Subsequently, Sram horizontal mapping may be performed. Specifically, the storage space contains 8 srams, the length of each sram line is 64 bits, and the depth of each sram is 72 bits. The eight srams are combined to have a width of 512 bits. Each piece of 16-bit data is mapped according to the vector offset coordinate thereof. At the same time, the Sram vertical mapping is performed. Specifically, each sram is 72-bit, and there are two search centers in total for each search. Each sram is partitioned into two parts: 0-35 and 36-72, and data of the two search centers are respectively mapped.
Step 108: the to-be-written residual data is written into a corresponding buffer according to the buffer index and the buffer address.

Optionally, a mask corresponding to the buffer index and the buffer address is generated, and the to-be-written residual data is written into the corresponding buffer according to the buffer index, the buffer address, and the mask.

Specifically, as shown in FIG. 2, the residual data is stored in the corresponding sram according to the sram index of the horizontal mapping, the sram address of the vertical mapping, and the corresponding mask. In such a manner, the residual data reading manner may be utilized to implement the parallel reading of the residual data. Residual data corresponding to adjacent motion vectors is stored in the same address in different buffers and can be read at the same time, and accordingly, the requirement of calculating two motion vectors at the same time is satisfied.

In the foregoing residual data writing method, the residual data reading mode is determined. The residual data reading mode may include a reading sequence of residual data and the quantity of residual data read simultaneously at each time. The number of the buffer groups and the number of the buffers in each buffer group are determined according to the residual data reading mode. Each buffer is provided with a unique buffer index, and each buffer includes a plurality of buffer addresses. The buffer index and the buffer address corresponding to the to-be-written residual data are acquired. The to-be-written residual data is written into the corresponding buffer according to the buffer index and the buffer address. The residual data of different coordinates is written into the buffer at once, in order to avoid writing the residual data of only one coordinate at a time, thereby significantly reducing clock periods for data writing, greatly reducing the write time of the residual data, and improving the access efficiency of the residual data.

In an embodiment, the step of acquiring the buffer index and the buffer address corresponding to the to-be-written residual data, and writing the to-be-written residual data into the corresponding buffer according to the buffer index and the buffer address may further include the following steps.

At first, The initial residual data acquired in the motion estimation target phase is partitioned to obtain 16-bit to-be-written residual data, the vector coordinate corresponding to the to-be-written residual data is acquired according to the positional relationship between the to-be-written residual data and the initial residual data, the search center point corresponding to the initial residual data is acquired, and the vector offset coordinate of the to-be-written residual data is obtained according to the offset between the vector coordinate and the search center point.

Buffer lines of all buffers with the same buffer depth are concatenated according to the buffer index of each buffer to obtain a concatenated buffer line, a concatenation width of the concatenated buffer line is acquired according to a width of a buffer line of each buffer, a first position mapping relationship between the to-be-written residual data and the concatenated buffer line is determined according to the vector offset coordinate and the concatenation width, and the to-be-written residual data includes first residual data and second residual data that correspond to two adjacent motion vectors respectively.

Further, a plurality of target buffers having a corresponding relationship are determined according to an arrangement sequence of buffers in each buffer group. Each of the target buffers belongs to a different buffer group, and the target buffers have the same arrangement sequence in respective corresponding buffer groups. A difference parameter is acquired according to a buffer index of each target buffer. A buffer group and a buffer corresponding to the first residual data, and a buffer group and a buffer corresponding to the second residual data are respectively determined according to the first position mapping relationship, to determine a first buffer index corresponding to the first residual data and a second buffer index corresponding to the second residual data. when the first buffer index is the same as the second buffer index, the second buffer index is corrected according to the difference parameter to obtain a third buffer index. The first buffer index serves as the buffer index corresponding to the first residual data, and the third buffer index serves as the buffer index corresponding to the second residual data.

Further, a second position mapping relationship between the to-be-written residual data and the buffer depth is determined according to the vector offset coordinate and the search center point. A buffer depth corresponding to the to-be-written residual data is determined according to the second position mapping relationship, to determine a buffer address corresponding to the to-be-written residual data.

Finally, a mask corresponding to the buffer index and the buffer address is generated. The to-be-written residual data is written into the corresponding buffer according to the buffer index, the buffer address, and the mask.

Specifically, in one aspect, the address mapping in the coarse search phase is taken as an example, and the foregoing specific implementation process may include:

### (1) Calculation of Vector Coordinate Offset

The vector coordinate of the search center is set as (scmvy, scmvx). The vector coordinate of a dark block in FIG. 3 is (cfmvy, cfmvx), with a serial number formed by a combination of C (the value of C ranges from 2′b00 to 2′b11) and R (the value of R ranges from 2′b00 to 2′b11). Then, the vector offset coordinates of every 16 pieces of data are shown in Table 1:

TABLE 1

| Serial | Block | |
|---|---|---|
| number | information | Coordinates |
| 4′b0000 | C0R0 | (scmvy − cfmvy, scmvx − cfmvx) |
| 4′b0001 | C0R1 | (scmvy − cfmvy, scmvx − cfmvx − 1) |
| 4′b0010 | C0R2 | (scmvy − cfmvy − 1, scmvx − cfmvx) |
| 4′b0011 | C0R3 | (scmvy − cfmvy − 1, scmvx − cfmvx − 1) |
| 4′b0100 | C0R4 | (scmvy − cfmvy, scmvx − cfmvx + 1) |
| 4′b0101 | C0R5 | (scmvy − cfmvy, scmvx − cfmvx) |
| 4′b0110 | C0R6 | (scmvy − cfmvy − 1, scmvx − cfmvx + 1) |
| 4′b0111 | C0R7 | (scmvy − cfmvy − 1, scmvx − cfmvx) |
| 4′b1000 | C0R8 | (scmvy − cfmvy + 1, scmvx − cfmvx) |
| 4′b1001 | C0R9 | (scmvy − cfmvy + 1, scmvx − cfmvx − 1) |
| 4′b1010 | C0R10 | (scmvy − cfmvy, scmvx − cfmvx) |
| 4′b1011 | C0R11 | (scmvy − cfmvy, scmvx − cfmvx − 1) |
| 4′b1100 | C0R12 | (scmvy − cfmvy + 1, scmvx − cfmvx + 1) |
| 4′b1101 | C0R13 | (scmvy − cfmvy + 1, scmvx − cfmvx) |
| 4′b1110 | C0R14 | (scmvy − cfmvy, scmvx − cfmvx + 1) |
| 4′b1111 | C0R15 | (scmvy − cfmvy, scmvx − cfmvx) |

### (2) Horizontal Mapping

The value of the horizontal mapping index ranges from 0 to 31. Since the storage layout is a Z-order layout, the coordinate index of data is as follows:

index=(Y[1],X[1],Y[0],X[0]).

In addition, data with adjacent coordinates is read using the same address at once, and indexes of the adjacent coordinates are the same, so that the coordinate index is as follows:

index=(Y[1],[1],Y[0]).

Since a piece of coordinate data consists of four pieces of 16-bit data, the reference block with the number parameter R is utilized to distinguish the data, so that the code is as follows:

index=(Y[1],X[1],Y[0],R[1],R[0]).

Considering the size of the CU is 32×32, there are four 16×16 blocks, and the data of the same coordinate exists in the same line. Assuming that the 16×16 block number is cu16[1:0], the code is as follows:

$$index = ( ( Y [ 1 ] , X [ 1 ] , Y [ 0 ] , R [ 1 ] , R [ 0 ] ) + ( cu 16 [ 1 : 0 ] , {2}^{′} b 00 ) ) .$$

In the foregoing formula, adjacent coordinates have the same index. To ensure that adjacent coordinates are correctly stored in the corresponding sram, the following operations are performed on the adjacent coordinates, to ensure that one coordinate is stored in the sram0-sram3 and the other is stored in the sram4-sram7.

If index[4]!=x[0], index=index−16, where 16 is equivalent to a difference parameter.

### (3) Vertical Mapping

Assuming that an offset coordinate in the x-direction is set as xoffset, and an offset coordinate in the y-direction is set as yoffset, then Addr is set as follows:

$$Addr = {base}_{addr} + xoffset [ 3 : 1 ] + yoffset [ 2 : 0 ] \times 4.$$

The search range is 8×8. Because the adjacent coordinates have the same address, xoffset is [3:1], and the address opening degree for each line is 4.

Each piece of 16-bit data corresponds to the mask for 512 bits as follows:

mask=1<<index.

### (4) Data Writing

Data needs to be shifted before the data is written, i.e., the data is shifted to a corresponding 512-bit position:

Data_sft=data<<index×16.

The data and mask are combined as follows:

Line_mask=mask0|mask1| . . . |mask15;

Line_data=data_sft0|datasft1| . . . |datasft15.

The line_mask is partitioned from the line_data, and data corresponding to the 0-7 sram is obtained and written into the corresponding sram according to the corresponding addr.

In another aspect, the address mapping in the fine search phase is taken as an example, and the specific implementation process may include:

### (1) Calculation of Vector Coordinate Offset

Referring to FIG. 5, each piece of 256-bit data in the fine search phase is characterized as residual data between one 8×8 block of a current block and all 8×8 blocks in a mv4×4 area of the reference block. Accordingly, the vector offset coordinate of each piece of 16-bit data may be obtained according to the positional relationship of the reference block. Taking a block C0 is as an example, the vector offset coordinate of the block C0 is shown in Table 2:

| Serial | Block | |
|---|---|---|
| number | information | Coordinate |
| 4′b0000 | C0R0 | (scmvy − cfmvy, scmvx − cfmvx) |
| 4′b0001 | C0R1 | (scmvy − cfmvy, scmvx − cfmvx + 4) |
| 4′b0010 | C0R2 | (scmvy − cfmvy, scmvx − cfmvx + 8) |
| 4′b0011 | C0R3 | (scmvy − cfmvy, scmvx − cfmvx + 12) |
| 4′b0100 | C0R4 | (scmvy − cfmvy + 4, scmvx − cfmvx) |
| 4′b0101 | C0R5 | (scmvy − cfmvy + 4, scmvx − cfmvx + 4) |
| 4′b0110 | C0R6 | (scmvy − cfmvy + 4, scmvx − cfmvx + 8) |
| 4′b0111 | C0R7 | (scmvy − cfmvy + 4, scmvx − cfmvx + 12) |
| 4′b1000 | C0R8 | (scmvy − cfmvy + 8, scmvx − cfmvx) |
| 4′b1001 | C0R9 | (scmvy − cfmvy + 8, scmvx − cfmvx + 4) |
| 4′b1010 | C0R10 | (scmvy − cfmvy + 8, scmvx − cfmvx + 8) |
| 4′b1011 | C0R11 | (scmvy − cfmvy + 8, scmvx − cfmvx + 12) |
| 4′b1100 | C0R12 | (scmvy − cfmvy + 12, scmvx − cfmvx) |
| 4′b1101 | C0R13 | (scmvy − cfmvy + 12, scmvx − cfmvx + 4) |
| 4′b1110 | C0R14 | (scmvy − cfmvy + 12, scmvx − cfmvx + 8) |
| 4′b1111 | C0R15 | (scmvy − cfmvy + 12, scmvx − cfmvx + 12) |

### (2) Horizontal Mapping

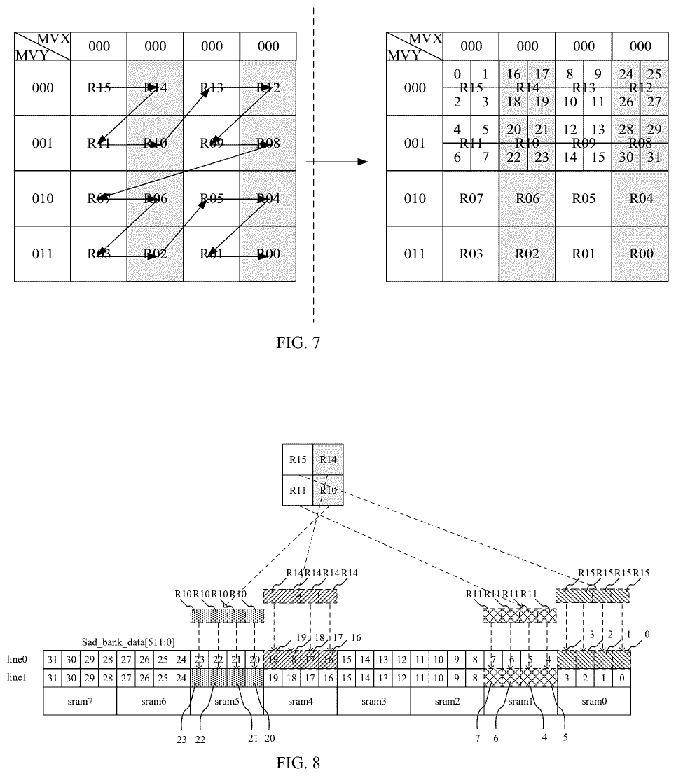

When a Z-order memory layout is used, the index is similar to that in the coarse search phase. The data is arranged in the sequence shown in FIG. 7, and each coordinate block includes four 8×8 blocks of residual data. As shown in FIG. 8, since the adjacent coordinates need to be read simultaneously, the adjacent coordinates are respectively stored in the same address in 0-3 sram and 4-7 sram. R15 and R14 are read simultaneously, data of the R15 is stored in SRAM0 line0, and data of the R14 is stored in SRAM4 line0. Accordingly, an initial index of the coordinate data of (0, 0) is 0, and an initial index of the coordinate data of (0, 1) is 16.

The horizontal mapping index may be derived from FIG. 8 as follows:

$$index = \{ X [ 0 ] , X [ 1 ] , Y [ 0 ] , {2}^{′} b 00 \} + C [ 1 : 0 ] ;$$

where C[1:0] is a serial number of the current block. When the current block is 32×32, there are four 16×16 blocks. The four blocks have the same coordinates and need to be read simultaneously. Therefore, the four blocks should be in 0-3 sram or 4-7 sram at the same time. The index is modified as follows:

$$index = ( ( X [ 0 ] , X [ 1 ] , Y [ 0 ] , {2}^{′} b 00 \} + \{ cu 16 [ 1 : 0 ] , C [ 1 : 0 ] \} .$$

In order to ensure that adjacent coordinate data is correctly stored in 0-3 sram and 4-7 sram, if (Index[4]!=X[0]), it indicates that the data that should be stored in 0-3 sram is stored in the 4-7 sram during the calculation overflow. The following operation is performed to ensure the correct storage: index=index−16, where 16 is equivalent to the difference parameter.

### (3) Vertical Mapping

The vertical mapping is a sram address corresponding to each piece of data, and is calculated as follows:

$$addr = baseaddr + xoffset [ 3 : 1 ] + Yoffset [ 2 : 0 ] \times 4 ;$$

where the value of xoffset is [3:1] because the adjacent coordinates have the same address. When the range is 8×8, yoffset×4, since the adjacent coordinates have the same address, the width of each line is regarded as 4.

### (4) Data Writing

Data writing in the fine search phase is the same as that in the coarse search phase, and details are not described herein again.

In the embodiment, data of nine different coordinates is written into the sram at a time during the coarse search phase. Compared with the conventional manner, seven clock periods are reduced per 256-bit data. During the fine search phase, data of 16 different coordinates is written into the sram at a time, and accordingly, 14 clock periods are reduced per 256-bit data compared to the conventional manner. When the residual data is read, the residual data of two adjacent coordinates can be read at a time, and accordingly, the MEE search efficiency is improved.

In an embodiment, the number of buffer groups, the number of buffers in each buffer group, and related parameters of the horizontal mapping and vertical mapping may be adjusted according to different video encoding and decoding requirements. The related parameters include but are not limited to a search range, a search block, a current block, and a size of a residual block.

Specifically, as the video resolution continuously increases, standards of video encoding and decoding also evolve as well, including a larger search range, a larger size of a search block, and modifications of the horizontal mapping and vertical mapping parameters, effect caused by the expanded search range and the expanded search block may be eliminated.

When the search range is expanded, the depth of the sram is correspondingly expanded, and a parameterized modification is performed on addr as follows:

$$Addr = xoffset [ Hbit 0 : 1 ] + Yoffset [ Hbit 1 : 0 ] \times ( width / 2 ) ;$$

where Hbit is determined by the search range. When the search range is expanded horizontally, the Hbit0 and the width are expanded. When the search range is expanded vertically, the Hbit1 is expanded.

When the search block becomes larger, the index is modified. Correspondingly, the number of the srams increases, and the parameterized modification is performed on addr as follows:

$$Index = zorder\_index * ( sram\_num / 2 ) + \{ cu\_idx [ Hbit 0 : 0 ] , suboffset [ Hbit 1 : 0 ] \} ;$$

where the parameters in the above formula are described as follows:
Zorder_index is a Z-order memory sequence;
Sram_num is the number of the required srams;
Cu_idx is a serial number of a current block; in the current HEVC, the size of the current block is 16×16, and there are four search blocks 32×32;
Suboffset is the serial number of the 8×8 residual block in cu16.

The search block is defined as Block, the current block is defined as MB, and the residual block is defined as subMB.

The index is modified as follows:

$$index = {zorder}_{index} \times \frac{{( {block}_{width} / 8 )}^{2}}{4} + \{ {cu}_{idx} [ {log}_{2} \frac{{block}_{width}}{{mb}_{width}} : 0 ] , suboffset [ {log}_{2} \frac{{MB}_{width}}{{subMB}_{width}} : 0 ] .$$

In the embodiment, if a new encoding standard is used, there is no need to redesign the mapping logics, and only corresponding buffer specifications and mapping parameters need to be adjusted, which has higher expandability.

In an embodiment, a residual data writing method includes the following steps.

A residual data reading circuit is provided. The residual data reading circuit includes two data interfaces; the two data interfaces are configured to simultaneously read residual data corresponding to two adjacent motion vectors in each residual data reading process; and residual data is read from the buffer at least once through the two data interfaces of the residual data reading circuit; the residual data reading mode includes a reading sequence of each piece of residual data and the quantity of residual data read simultaneously at each time.

The residual data corresponding to two adjacent motion vectors read simultaneously in each residual data reading process is determined according to the residual data reading mode, to configure two buffer groups; the same number of buffers is configured in each buffer group; each buffer is provided with a unique buffer index, and each buffer includes a plurality of buffer addresses.

Initial residual data acquired in a target phase of the motion estimation is partitioned to obtain 16-bit to-be-written residual data; a vector coordinate corresponding to the to-be-written residual data is acquired according to the positional relationship between the to-be-written residual data and the initial residual data; a search center point corresponding to the initial residual data is acquired, and a vector offset coordinate of the to-be-written residual data is obtained according to an offset between the vector coordinate and the search center point.

Buffer lines of all buffers with the same buffer depth are concatenated according to the buffer index of each buffer to obtain a concatenated buffer line; a concatenation width of the concatenated buffer line is acquired according to a width of a buffer line of each buffer; a first position mapping relationship between the to-be-written residual data and the concatenated buffer line is determined according to the vector offset coordinate and the concatenation width; the to-be-written residual data includes first residual data and second residual data, and the first residual data and the second residual data correspond to two adjacent motion vectors respectively.

A plurality of target buffers having a corresponding relationship are determined according to an arrangement sequence of buffers in each buffer group; each of the target buffers belongs to a different buffer group, and the target buffers have the same arrangement sequence in respective corresponding buffer groups; a difference parameter is acquired according to a buffer index of each target buffer; a buffer group and a buffer corresponding to the first residual data, and a buffer group and a buffer corresponding to the second residual data are respectively determined according to the first position mapping relationship, to determine a first buffer index corresponding to the first residual data and a second buffer index corresponding to the second residual data; when the first buffer index is the same as the second buffer index, the second buffer index is corrected according to the difference parameter to obtain a third buffer index; the first buffer index serves as the buffer index corresponding to the first residual data, and the third buffer index serves as the buffer index corresponding to the second residual data.

A second position mapping relationship between the to-be-written residual data and the buffer depth is determined according to the vector offset coordinate and the search center point; and a buffer depth corresponding to the to-be-written residual data is determined according to the second position mapping relationship, to determine a buffer address corresponding to the to-be-written residual data.

A mask corresponding to the buffer index and the buffer address is generated; the to-be-written residual data is written into the corresponding buffer according to the buffer index, the buffer address, and the mask.

It should be appreciated that, although the steps in the flow chart involved in the embodiments described above are shown sequentially as indicated by the arrows, they are not definitely performed sequentially in the order indicated by the arrows. Unless explicitly stated in this article, there is no strict order in which these steps are executed, and these steps can be executed in other order. Moreover, at least some of the steps in the flow chart referred to in the embodiments mentioned above may include multiple steps or stages, which are not definitely performed at the same time, but may be performed at different moments, and these steps or stages are not definitely performed in sequence, but can be performed in turns or alternately with other steps or at least partial steps or phases within other steps.

Based on the same invention concept, in an embodiment of the present disclosure, a residual data writing apparatus for implementing the foregoing residual data writing method is provided. An implementation provided by the apparatus is similar to the implementation described in the foregoing method. Therefore, for the specific limitations in one or more embodiments of the residual data writing apparatus provided below, reference can be made to the foregoing limitations on the residual data writing method, which will not be repeated herein.

In an exemplary embodiment, as shown in FIG. 9, a residual data writing apparatus 900 is provided, including a determination module 901, a configuration module 902, an acquisition module 903, and a writing module 904.

The determination module 901 is configured to determine a residual data reading mode including a reading sequence of each piece of residual data, and the quantity of residual data read simultaneously at each time.

The configuration module 902 is configured to determine the number of buffer groups and the number of buffers in each buffer group according to the residual data reading mode, in which each buffer is provided with a unique buffer index, and each buffer includes a plurality of buffer addresses.

The acquisition module 903 is configured to acquire a buffer index and a buffer address corresponding to the to-be-written residual data.

The writing module 904 is configured to write the to-be-written residual data into a corresponding buffer according to the buffer index and the buffer address.

In an embodiment, the determination module 901 is further configured to: configure a residual data reading circuit including two data interfaces, in which the two data interfaces are configured to simultaneously read residual data corresponding to two adjacent motion vectors in each residual data reading process, and read the residual data from the buffer at least once through the two data interfaces of the residual data reading circuit.

In an embodiment, the configuration module 902 is further configured to determine residual data corresponding to two adjacent motion vectors read simultaneously in each residual data reading process according to the residual data reading mode to configure two buffer groups, and configure the same number of buffers in each buffer group.

In an embodiment, the acquisition module 903 is further configured to: partition initial residual data acquired in the motion estimation target phase to obtain 16-bit to-be-written residual data; acquire a vector coordinate corresponding to the to-be-written residual data according to a positional relationship between the to-be-written residual data and the initial residual data; acquire a search center point corresponding to the initial residual data; obtain a vector offset coordinate of the to-be-written residual data according to an offset between the vector coordinate and the search center point; and acquire the buffer index and the buffer address corresponding to the to-be-written residual data according to the vector offset coordinate.

In an embodiment, the acquisition module 903 is further configured to: concatenate buffer lines of all buffers with the same buffer depth according to the buffer index of each buffer to obtain a concatenated buffer line; acquire a concatenation width of the concatenated buffer line according to a width of a buffer line of each buffer; determine a first position mapping relationship between the to-be-written residual data and the concatenated buffer line according to the vector offset coordinate and the concatenation width; and determine the buffer group and the buffer corresponding to the to-be-written residual data according to the first position mapping relationship, to determine the buffer index corresponding to the to-be-written residual data.

In an embodiment, the to-be-written residual data includes first residual data and second residual data which correspond to two adjacent motion vectors. The acquisition module 903 is further configured to: determine a plurality of target buffers having a corresponding relationship according to an arrangement sequence of buffers in each buffer group, in which each of the target buffers belongs to a different buffer group, and the target buffers have the same arrangement sequence in respective corresponding buffer groups; acquire a difference parameter according to a buffer index of each target buffer; determine a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data; when the first buffer index is the same as the second buffer index, correct the second buffer index according to the difference parameter to obtain a third buffer index; determine the first buffer index as the buffer index corresponding to the first residual data, and determine the third buffer index as the buffer index corresponding to the second residual data.

In an embodiment, the acquisition module 903 is further configured to: determine a second position mapping relationship between the to-be-written residual data and the buffer depth according to the vector offset coordinate and the search center point; and determine a buffer depth corresponding to the to-be-written residual data according to the second position mapping relationship, to determine the buffer address corresponding to the to-be-written residual data.

In an embodiment, the writing module 904 is further configured to generate a mask corresponding to the buffer index and the buffer address, and write the to-be-written residual data into the corresponding buffer according to the buffer index, the buffer address, and the mask.

All or a part of the modules in the above-mentioned residual data writing apparatus may be implemented by using software, hardware, and a combination thereof. The foregoing modules may be embedded in or independent of a processor in the computer device in a hardware form, or may be stored in a memory in the computer device in a software form, so that the processor may invoke to execute operations corresponding to the foregoing modules.

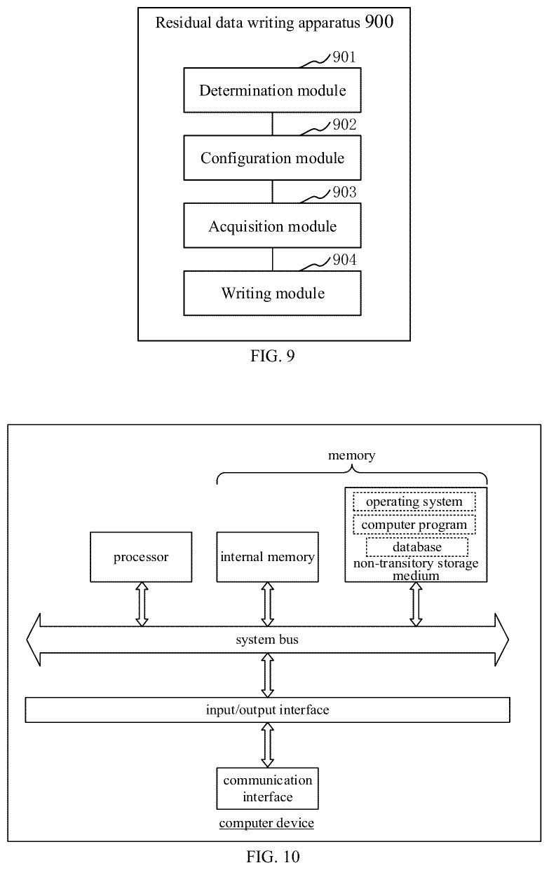

In an exemplary embodiment, a computer device is provided. The computer device may be a server, and an internal structure diagram of the computer device may be as shown in FIG. 10. The computer device may include a processor, a memory, an Input/Output (Input/Output, I/O for short), and a communication interface. The processor, the memory, and the input/output interface are connected to the system bus by using a system bus, and the communication interface is connected to the system bus by using the input/output interface. The processor of the computer device is configured to provide a computing and control capabilities. The memory of the computer device may include a non-transitory storage medium and an internal memory. The non-transitory storage medium stores an operating system, a computer program, and a database. The internal memory provides an environment for running an operating system and a computer program in a non-transitory storage medium. The database of the computer device is configured to store video data. The input/output interface of the computer device is configured to exchange information between the processor and an external device. The communication interface of the computer device is configured to communicate with an external terminal through a network connection. The computer program is executed by a processor to implement a residual data writing method.

A person skilled in the art may understand that the structure shown in FIG. 10 is merely a block diagram of partial structure related to the solution of the present disclosure, and does not constitute a limitation on a computer device to which the solution of the present disclosure is applied. A specific computer device may include more or less components than those shown in the figure, or combine some components, or have different component arrangements.

In an exemplary embodiment, a computer device is provided, including a processor and a memory storing a computer program, the processor, when executing the computer program, may implement the following steps of: determining a residual data reading mode including a reading sequence of each piece of residual data, and the quantity of residual data read simultaneously at each time, determining the number of buffer groups and the number of buffers in each buffer group according to the residual data reading mode, in which each buffer is provided with a unique buffer index, and each buffer includes a plurality of buffer addresses, acquiring a buffer index and a buffer address corresponding to the to-be-written residual data, writing the to-be-written residual data into a corresponding buffer according to the buffer index and the buffer address.

In an embodiment, the processor, when executing the computer program, may further implement the following steps of: configuring a residual data reading circuit including two data interfaces configured to simultaneously read residual data corresponding to two adjacent motion vectors in each residual data reading process, and reading the residual data from the buffer at least once through the two data interfaces of the residual data reading circuit.

In an embodiment, the processor, when executing the computer program, may further implement the following steps of: determining residual data corresponding to two adjacent motion vectors read simultaneously in each residual data reading process according to the residual data reading mode, to configure two buffer groups, and configuring the same number of buffers in each buffer group.

In an embodiment, the processor, when executing the computer program, may further implement the following steps of: partitioning initial residual data acquired in the motion estimation target phase to obtain 16-bit to-be-written residual data; acquiring a vector coordinate corresponding to the to-be-written residual data according to a positional relationship between the to-be-written residual data and the initial residual data; acquiring a search center point corresponding to the initial residual data; obtaining a vector offset coordinate of the to-be-written residual data according to an offset between the vector coordinate and the search center point; and acquiring the buffer index and the buffer address corresponding to the to-be-written residual data according to the vector offset coordinate.

In an embodiment, the processor, when executing the computer program, may further implement the following steps of: concatenating buffer lines of all buffers with the same buffer depth according to the buffer index of each buffer to obtain a concatenated buffer line; acquiring a concatenation width of the concatenated buffer line according to a width of a buffer line of each buffer; determining a first position mapping relationship between the to-be-written residual data and the concatenated buffer line according to the vector offset coordinate and the concatenation width; and determining the buffer group and the buffer corresponding to the to-be-written residual data according to the first position mapping relationship, to determine the buffer index corresponding to the to-be-written residual data.

In an embodiment, the to-be-written residual data may include first residual data and second residual data which correspond to two adjacent motion vectors. The processor, when executing the computer program, may further implement the following steps of: determining a plurality of target buffers having a corresponding relationship according to an arrangement sequence of buffers in each buffer group, in which each of the target buffers belongs to a different buffer group, and the target buffers have the same arrangement sequence in respective corresponding buffer groups; acquiring a difference parameter according to a buffer index of each target buffer; determining a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data; when the first buffer index is the same as the second buffer index, correcting the second buffer index according to the difference parameter to obtain a third buffer index; determining the first buffer index as the buffer index corresponding to the first residual data, and determining the third buffer index as the buffer index corresponding to the second residual data.

In an embodiment, the processor, when executing the computer program, may further implement the following steps of: determining a second position mapping relationship between the to-be-written residual data and the buffer depth according to the vector offset coordinate and the search center point; and determining a buffer depth corresponding to the to-be-written residual data according to the second position mapping relationship, to determine the buffer address corresponding to the to-be-written residual data.

In an embodiment, the processor, when executing the computer program, may further implement the following steps of: generating a mask corresponding to the buffer index and the buffer address, and writing the to-be-written residual data into the corresponding buffer according to the buffer index, the buffer address, and the mask.

In an embodiment, a computer readable storage medium is provided, on which a computer program is stored. The computer program, when executed by a processor, may cause the processor to implement the following steps of: determining a residual data reading mode including a reading sequence of each piece of residual data, and the quantity of residual data read simultaneously at each time, determining the number of buffer groups and the number of buffers in each buffer group according to the residual data reading mode, in which each buffer is provided with a unique buffer index, and each buffer includes a plurality of buffer addresses, acquiring a buffer index and a buffer address corresponding to the to-be-written residual data, writing the to-be-written residual data into a corresponding buffer according to the buffer index and the buffer address.

In an embodiment, the computer program, when executed by the processor, may further cause the processor to implement the following steps of: configuring a residual data reading circuit including two data interfaces configured to simultaneously read residual data corresponding to two adjacent motion vectors in each residual data reading process, and reading the residual data from the buffer at least once through the two data interfaces of the residual data reading circuit.

In an embodiment, the computer program, when executed by the processor, may further cause the processor to implement the following steps of: are further implemented: determining residual data corresponding to two adjacent motion vectors read simultaneously in each residual data reading process according to the residual data reading mode, to configure two buffer groups, and configuring the same number of buffers in each buffer group.

In an embodiment, the computer program, when executed by the processor, may further cause the processor to implement the following steps of: partitioning initial residual data acquired in the motion estimation target phase to obtain 16-bit to-be-written residual data; acquiring a vector coordinate corresponding to the to-be-written residual data according to a positional relationship between the to-be-written residual data and the initial residual data; acquiring a search center point corresponding to the initial residual data; obtaining a vector offset coordinate of the to-be-written residual data according to an offset between the vector coordinate and the search center point; and acquiring the buffer index and the buffer address corresponding to the to-be-written residual data according to the vector offset coordinate.

In an embodiment, the computer program, when executed by the processor, may further cause the processor to implement the following steps of: concatenating buffer lines of all buffers with the same buffer depth according to the buffer index of each buffer to obtain a concatenated buffer line; acquiring a concatenation width of the concatenated buffer line according to a width of a buffer line of each buffer; determining a first position mapping relationship between the to-be-written residual data and the concatenated buffer line according to the vector offset coordinate and the concatenation width; and determining the buffer group and the buffer corresponding to the to-be-written residual data according to the first position mapping relationship, to determine the buffer index corresponding to the to-be-written residual data.

In an embodiment, the to-be-written residual data may include first residual data and second residual data which correspond to two adjacent motion vectors. The computer program, when executed by the processor, may further cause the processor to implement the following steps of: determining a plurality of target buffers having a corresponding relationship according to an arrangement sequence of buffers in each buffer group, in which each of the target buffers belongs to a different buffer group, and the target buffers have the same arrangement sequence in respective corresponding buffer groups; acquiring a difference parameter according to a buffer index of each target buffer; determining a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data; when the first buffer index is the same as the second buffer index, correcting the second buffer index according to the difference parameter to obtain a third buffer index; determining the first buffer index as the buffer index corresponding to the first residual data, and determining the third buffer index as the buffer index corresponding to the second residual data.

In an embodiment, the computer program, when executed by the processor, may further cause the processor to implement the following steps of: determining a second position mapping relationship between the to-be-written residual data and the buffer depth according to the vector offset coordinate and the search center point; and determining a buffer depth corresponding to the to-be-written residual data according to the second position mapping relationship, to determine the buffer address corresponding to the to-be-written residual data.

In an embodiment, the computer program, when executed by the processor, may further cause the processor to implement the following steps of: generating a mask corresponding to the buffer index and the buffer address, and writing the to-be-written residual data into the corresponding buffer according to the buffer index, the buffer address, and the mask.

In an embodiment, a computer program product is provided, including a computer program. The computer program, when executed by a processor, may cause the processor to implement the following steps of: determining a residual data reading mode including a reading sequence of each piece of residual data, and the quantity of residual data read simultaneously at each time, determining the number of buffer groups and the number of buffers in each buffer group according to the residual data reading mode, in which each buffer is provided with a unique buffer index, and each buffer includes a plurality of buffer addresses, acquiring a buffer index and a buffer address corresponding to the to-be-written residual data, writing the to-be-written residual data into a corresponding buffer according to the buffer index and the buffer address.

In an embodiment, the computer program, when executed by the processor, may further cause the processor to implement the following steps of: configuring a residual data reading circuit including two data interfaces configured to simultaneously read residual data corresponding to two adjacent motion vectors in each residual data reading process, and reading the residual data from the buffer at least once through the two data interfaces of the residual data reading circuit.

In an embodiment, the computer program, when executed by the processor, may further cause the processor to implement the following steps of: determining residual data corresponding to two adjacent motion vectors read simultaneously in each residual data reading process according to the residual data reading mode, to configure two buffer groups, and configuring the same number of buffers in each buffer group.

In an embodiment, the computer program, when executed by the processor, may further cause the processor to implement the following steps of: partitioning initial residual data acquired in the motion estimation target phase to obtain 16-bit to-be-written residual data; acquiring a vector coordinate corresponding to the to-be-written residual data according to a positional relationship between the to-be-written residual data and the initial residual data; acquiring a search center point corresponding to the initial residual data; obtaining a vector offset coordinate of the to-be-written residual data according to an offset between the vector coordinate and the search center point; and acquiring the buffer index and the buffer address corresponding to the to-be-written residual data according to the vector offset coordinate.

In an embodiment, the computer program, when executed by the processor, may further cause the processor to implement the following steps of: concatenating buffer lines of all buffers with the same buffer depth according to the buffer index of each buffer to obtain a concatenated buffer line; acquiring a concatenation width of the concatenated buffer line according to a width of a buffer line of each buffer; determining a first position mapping relationship between the to-be-written residual data and the concatenated buffer line according to the vector offset coordinate and the concatenation width; and determining the buffer group and the buffer corresponding to the to-be-written residual data according to the first position mapping relationship, to determine the buffer index corresponding to the to-be-written residual data.

In an embodiment, the to-be-written residual data may include first residual data and second residual data which correspond to two adjacent motion vectors. The computer program, when executed by the processor, may further cause the processor to implement the following steps of: determining a plurality of target buffers having a corresponding relationship according to an arrangement sequence of buffers in each buffer group, in which each of the target buffers belongs to a different buffer group, and the target buffers have the same arrangement sequence in respective corresponding buffer groups; acquiring a difference parameter according to a buffer index of each target buffer; determining a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data; when the first buffer index is the same as the second buffer index, correcting the second buffer index according to the difference parameter to obtain a third buffer index; determining the first buffer index as the buffer index corresponding to the first residual data, and determining the third buffer index as the buffer index corresponding to the second residual data.

In an embodiment, the computer program, when executed by the processor, may further cause the processor to implement the following steps of: determining a second position mapping relationship between the to-be-written residual data and the buffer depth according to the vector offset coordinate and the search center point; and determining a buffer depth corresponding to the to-be-written residual data according to the second position mapping relationship, to determine the buffer address corresponding to the to-be-written residual data.

In an embodiment, the computer program, when executed by the processor, may further cause the processor to implement the following steps of: generating a mask corresponding to the buffer index and the buffer address, and writing the to-be-written residual data into the corresponding buffer according to the buffer index, the buffer address, and the mask.

It should be noted that user information (including but not limited to user device information, user personal information, and the like) and data (including but not limited to data used for analysis, stored data, and displayed data) involved in the present disclosure are authorized by a user or fully authorized by each party, and collection, use, and processing of related data need to comply with a related regulation.

It should be noted that the user information (including but not limited to user device information, user personal information, etc.) and data (including but not limited to data for analysis, stored data, displayed data, etc.) involved in the present disclosure are all information and data authorized by the user or fully authorized by all parties, and the collection, use and processing of relevant data need to comply with relevant laws, regulations and standards of relevant countries and regions.

Those of ordinary skill in the art can understand that all or part of the procedures in the method of the above embodiments can be implemented by instructing relevant hardware through a computer program, and the computer program can be stored in a non-transitory computer-readable storage medium, when the computer program is executed, the procedures in the above-mentioned method embodiments can be performed. Any reference to a memory, a database or other media used in the various embodiments provided in the present disclosure may include at least one of a non-transitory memory and a transitory memory. The non-transitory memory may include a read-only memory (ROM), a magnetic tape, a floppy disk, a flash memory, an optical memory, a high-density embedded non-transitory memory, a resistive memory (ReRAM), a magnetoresistive random access memory (MRAM), a ferroelectric random access memory (FRAM), a phase change memory (PCM), a graphene memory, etc. The transitory memory may include a random access memory (RAM) or an external cache memory, and the like. As an illustration and not a limitation, the RAM may be in various forms, such as a static random access memory (SRAM) or a dynamic random access memory (DRAM). The database involved in the various embodiments provided in the present disclosure may include at least one of a relational database and a non-relational database. The non-relational database may include a tilechain-based distributed database, etc., but is not limited thereto. The processor involved in the various embodiments provided in the present disclosure may be a general-purpose processor, a central processing unit, a graphics processor, a digital signal processor, a programmable logic device, a data processing logic device based on quantum computation, etc., but is not limited thereto.

The technical limitations in the above embodiments can be combined arbitrarily. In order to make the description concise, all possible combinations of the technical limitations in the above embodiments are not described. However, as long as there is no contradiction in the combination of these technical limitations, theses combinations considered to fall within the scope of the present disclosure.

The above-mentioned embodiments merely some exemplary embodiments of the present disclosure, and the descriptions thereof are relatively specific and detailed, but should not be construed as a limitation on the scope of the present disclosure. It should be pointed out that those skilled in the art can make several modifications and improvements without departing from the concept of the present disclosure, which all belong to the protection scope of the present disclosure. Therefore, the scope of protection of the present disclosure is subject to the appended claims.

What is claimed is:

1. A residual data writing method, comprising:
determining a residual data reading mode comprising a reading sequence of each piece of residual data, and the quantity of residual data read simultaneously at each time;
determining the number of buffer groups and the number of buffers in each buffer group according to the residual data reading mode, wherein each buffer is provided with a unique buffer index, and each buffer comprises a plurality of buffer addresses;
acquiring a buffer index and a buffer address corresponding to to-be-written residual data; and
writing the to-be-written residual data into a corresponding buffer according to the buffer index and the buffer address.

2. The method according to claim 1, wherein the determining the residual data reading mode comprises:
configuring a residual data reading circuit comprising two data interfaces which are configured to simultaneously read residual data corresponding to two adjacent motion vectors in each residual data reading process; and
reading the residual data from the buffer at least once through the two data interfaces of the residual data reading circuit.

3. The method according to claim 1, wherein the determining the number of buffer groups and the number of buffers in each buffer group according to the residual data reading mode comprises:
determining residual data corresponding to two adjacent motion vectors read simultaneously in each residual data reading process according to the residual data reading mode, to configure two buffer groups; and
configuring the same number of buffers in each buffer group.

4. The method according to claim 1, wherein the acquiring the buffer index and the buffer address corresponding to the to-be-written residual data comprises:
partitioning initial residual data acquired in a motion estimation target phase to obtain 16-bit to-be-written residual data;
acquiring a vector coordinate corresponding to the to-be-written residual data according to a positional relationship between the to-be-written residual data and the initial residual data;
acquiring a search center point corresponding to the initial residual data, and obtaining a vector offset coordinate of the to-be-written residual data according to an offset between the vector coordinate and the search center point; and
acquiring the buffer index and the buffer address corresponding to the to-be-written residual data according to the vector offset coordinate.

5. The method according to claim 4, wherein the acquiring the buffer index corresponding to the to-be-written residual data according to the vector offset coordinate comprises:
concatenating buffer lines of all buffers with the same buffer depth according to a buffer index of each buffer to obtain a concatenated buffer line;
acquiring a concatenation width of the concatenated buffer line according to a width of a buffer line of each buffer;
determining a first position mapping relationship between the to-be-written residual data and the concatenated buffer line according to the vector offset coordinate and the concatenation width; and
determining a buffer group and a buffer corresponding to the to-be-written residual data according to the first position mapping relationship, to determine the buffer index corresponding to the to-be-written residual data.

6. The method according to claim 5, wherein the to-be-written residual data comprises first residual data and second residual data which correspond to two adjacent motion vectors, and the determining the buffer group and the buffer corresponding to the to-be-written residual data according to the first position mapping relationship to determine the buffer index corresponding to the to-be-written residual data comprises:
determining a plurality of target buffers having a corresponding relationship according to an arrangement sequence of buffers in each buffer group, wherein each of the target buffers belongs to a different buffer group, and the target buffers have the same arrangement sequence in respective corresponding buffer groups;
acquiring a difference parameter according to a buffer index of each target buffer;
determining a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data;
when the first buffer index is the same as the second buffer index, correcting the second buffer index according to the difference parameter to obtain a third buffer index; and
determining the first buffer index as a buffer index corresponding to the first residual data, and determining the third buffer index as a buffer index corresponding to the second residual data.

7. The method according to claim 4, wherein the acquiring the buffer address corresponding to the to-be-written residual data according to the vector offset coordinate comprises:
determining a second position mapping relationship between the to-be-written residual data and a buffer depth according to the vector offset coordinate and the search center point; and
determining a buffer depth corresponding to the to-be-written residual data according to the second position mapping relationship, to determine the buffer address corresponding to the to-be-written residual data.

8. The method according to claim 1, wherein the writing the to-be-written residual data into the corresponding buffer according to the buffer index and the buffer address comprises:
generating a mask corresponding to the buffer index and the buffer address; and
writing the to-be-written residual data into the corresponding buffer according to the buffer index, the buffer address, and the mask.

9. A residual data writing apparatus, comprising:
a determination module, configured to determine a residual data reading mode comprising a reading sequence of each piece of residual data, and the quantity of residual data read simultaneously at each time;
a configuration module, configured to determine the number of buffer groups and the number of buffers in each buffer group according to the residual data reading mode, wherein each buffer is provided with a unique buffer index, and each buffer comprises a plurality of buffer addresses;
an acquisition module, configured to acquire a buffer index and a buffer address corresponding to to-be-written residual data; and
a writing module, configured to write the to-be-written residual data into a corresponding buffer according to the buffer index and the buffer address.

10. The apparatus according to claim 9, wherein the determination module is further configured to: configure a residual data reading circuit comprising two data interfaces, wherein the two data interfaces are configured to simultaneously read residual data corresponding to two adjacent motion vectors in each residual data reading process, and read the residual data from a buffer at least once through the two data interfaces of the residual data reading circuit.

11. The apparatus according to claim 9, wherein the configuration module is further configured to determine residual data corresponding to two adjacent motion vectors read simultaneously in each residual data reading process according to the residual data reading mode to configure two buffer groups, and configure the same number of buffers in each buffer group.

12. The apparatus according to claim 9, wherein the acquisition module is further configured to: partition initial residual data acquired in the motion estimation target phase to obtain 16-bit to-be-written residual data; acquire a vector coordinate corresponding to the to-be-written residual data according to a positional relationship between the to-be-written residual data and the initial residual data; acquire a search center point corresponding to the initial residual data; obtain a vector offset coordinate of the to-be-written residual data according to an offset between the vector coordinate and the search center point; and acquire the buffer index and the buffer address corresponding to the to-be-written residual data according to the vector offset coordinate.

13. The apparatus according to claim 9, wherein the acquisition module is further configured to: concatenate buffer lines of all buffers with the same buffer depth according to the buffer index of each buffer to obtain a concatenated buffer line; acquire a concatenation width of the concatenated buffer line according to a width of a buffer line of each buffer; determine a first position mapping relationship between the to-be-written residual data and the concatenated buffer line according to the vector offset coordinate and the concatenation width; and determine the buffer group and the buffer corresponding to the to-be-written residual data according to the first position mapping relationship, to determine the buffer index corresponding to the to-be-written residual data.

14. The apparatus according to claim 9, wherein the to-be-written residual data comprises first residual data and second residual data which correspond to two adjacent motion vectors, the acquisition module is further configured to: determine a plurality of target buffers having a corresponding relationship according to an arrangement sequence of buffers in each buffer group, in which each of the target buffers belongs to a different buffer group, and the target buffers have the same arrangement sequence in respective corresponding buffer groups; acquire a difference parameter according to a buffer index of each target buffer; determine a buffer group and a buffer corresponding to the first residual data, and a buffer group and a buffer corresponding to the second residual data respectively according to the first position mapping relationship, to determine a first buffer index corresponding to the first residual data and a second buffer index corresponding to the second residual data; when the first buffer index is the same as the second buffer index, correct the second buffer index according to the difference parameter to obtain a third buffer index; determine the first buffer index as the buffer index corresponding to the first residual data, and determine the third buffer index as the buffer index corresponding to the second residual data.

15. The apparatus according to claim 12, wherein the acquisition module is further configured to: determine a second position mapping relationship between the to-be-written residual data and the buffer depth according to the vector offset coordinate and the search center point; and determine a buffer depth corresponding to the to-be-written residual data according to the second position mapping relationship, to determine the buffer address corresponding to the to-be-written residual data.

16. The apparatus according to claim 9, wherein the writing module is further configured to generate a mask corresponding to the buffer index and the buffer address, and write the to-be-written residual data into the corresponding buffer according to the buffer index, the buffer address, and the mask.

17. A computer device, comprising a processor and a memory storing a computer program, wherein the processor, when executing the computer program, implements the method of claim 1.

18. A computer-readable storage medium, on which a computer program is stored, wherein the computer program, when executed by a processor, causes the processor to implement the method of claim 1.

19. A computer program product, comprising a computer program, wherein the computer program, when executed by a processor, causes the processor to implement the method of claim 1.
